(19) United States
(12) Patent Application Publication
(10) Pub. No.: US 2016/0000272 A1
(43) Pub. Date: Jan. 7, 2016

(54) SLIDING DOOR FOR WALK-IN BATHTUB

(71) Applicant: Fred X Jin, Diamond Bar, CA (US)

(72) Inventor: Fred X Jin, Diamond Bar, CA (US)

(21) Appl. No.: 14/791,236

(22) Filed: Jul. 2, 2015

Related U.S. Application Data
(60) Provisional application No. 62/019,942, filed on Jul. 2, 2014.

(51) Int. Cl. A47K 3/00; E05D 15/10; E06B 7/16; E05D 15/06; A47K 3/04; E05C 19/00

(52) U.S. Cl. CPC A47K 3/006; A47K 3/04; E05C 19/006; E06B 7/16; E05D 15/0608; E05D 15/10; E05D 15/0686

(57) ABSTRACT

A walk-in bathtub is disclosed, which may include a bathtub frame and a sliding door. The bathtub frame has a door receiving space to receive the sliding door and the sliding door may include a plurality of door seals that can be attached to the outer wall of the door receiving space to secure the sliding door. The door also includes a door lock, so when the door is appropriately positioned in the door receiving space, the door lock is used to further secure the door in a fixed position. The bathtub may include a pair of bottom sliding rails and the sliding door can travel thereon, and one end of each bottom sliding rail is curved to a predetermined extent to cause the sliding door to slightly tilt before entering the receiving space.

### CROSS-REFERENCE TO RELATED APPLICATIONS

This application claims priority under 35 U.S.C. §119 (e) to U.S. Provisional Patent Application Ser. No. 62/019,942 filed on Jul. 2, 2014, the entire contents of which are hereby incorporated by reference.

### FIELD OF THE INVENTION

The invention relates to sliding doors, and in particular to a walk-in bathtub having a sliding door capable of opening and closing an entrance thereof.

### BACKGROUND OF THE INVENTION

Traditional bathtubs may have high sidewalls, which allow a bathtub to hold a large volume of water. Many individuals, particularly the elderly and those suffering from arthritis, debilitating injury, handicap, and/or general loss of mobility, may have trouble accessing a bathtub area due to the high step that is typically required to step into and out of a bathtub. For such persons, the sidewall of a bathtub may be an insurmountable hurdle. Even with the assistance of a health aide, many individuals may not be capable of safely stepping over the sidewall of a bathtub and into the bathtub to take a bath or shower. Consequently, for people who have physical limitations may forego taking a bath or shower altogether and settle for alternate bathing methods, such as sponge baths and the like. Many people, however, may not find such alternative bathing methods satisfactory.

Walk-in bathtubs may have high tub walls with a high built in seat and a side door, allowing the user to walk into the tub from the side and sit down without having to climb down into a low bathtub. FIG. 1 shows a typical example of a walk-in bathtub in accordance with the prior art. Walk-in tubs are particularly suited for individuals who have physical limitations that make it difficult or dangerous to climb into and out of a regular, low bathtub or to stand up in a shower for extended periods of time. Such limitations might include physical disabilities or simply the reduced strength, balance and range of motion that typically occur with advancing age. Walk-in tubs are not only easier to enter and exit than conventional bathtubs, they also reduce the chances of slips and falls compared to conventional tubs and showers.

In addition to safety, the ease of entering the tub via the side walk-in door also provides users with independence, allowing them to bathe without the assistance of another person when getting into and out of the tub. However, the door of the conventional walk-in bathtub is connected to the main body thereof through one or more hinges. In general, the hinges in the bathroom would become rusty more easily than in other places because the bathroom is usually wet and moisturized, which may adversely affect the seal between the door and the bathtub body to further cause leaking of the bathtub.

U.S. Pat. Pub. No.: 2010/0037382 to Spiker et al. discloses a method of installing a low step entryway in a bathtub wall structure by converting a conventional bathtub or the like to a low step shower unit. However, Spiker does not particularly focus on the door of the entrance of the bathtub. U.S. Pat. No. 8,239,979 discloses to Colchester discloses a modular easy access bathing enclosure having a pocket door that is provided for enclosing the access opening and is movable into the sidewall surrounding the standing area. Moreover, the packet door has inflatable gaskets for sealing and locking the door in the access opening. However, the gasket may not provide a leakproof seal. Therefore, there remains a need for a new and improved door for the walk-in bathtub to overcome the problems stated above.

### SUMMARY OF THE INVENTION

It is an object of the present invention to provide a bathtub with low sidewall, so that the user can easily enter and exit the bathtub.

It is another object of the present invention to provide a walk-in bathtub with an improved sliding door that can be easily moved by the user and tightly fit into the entrance of the bathtub.

It is a further object of the present invention to provide a walk-in bathtub with an improved sliding door that can be guided by a top rail and a pair of bottom rails to precisely fit into the entrance of the bathtub.

It is still a further object of the present invention to provide a walk-in bathtub with an improved sliding door to prevent the water in the bathtub from leaking.

In one aspect, a bathtub may include a bathtub frame and a sliding door. The bathtub frame has a door receiving space to receive the sliding door and the sliding door may include a plurality of door seals that can be attached to the outer wall of the door receiving space to secure the sliding door. The door also includes a door lock, so when the door is appropriately positioned in the door receiving space, the door lock can be used to further secure the door in a fixed position.

In an exemplary embodiment, the bathtub may include a pair of bottom sliding rails and the sliding door can travel thereon. The bottom sliding rails are secured by a pair of mounting brackets, and it is noted that one end of each bottom sliding rail is curved to a predetermined extent to cause the sliding door to slightly tilt before entering the receiving space. It is also noted that the tilted angle of the sliding door before entering the receiving space is corresponding to the curved end of the bottom sliding rails, so that the door seals can be more effectively attach to the wall of the bath frame to secure the door.

In another embodiment, in addition to the door seals, a second seal is formed at the periphery of the receiving space to assured that the door is tightly positioned therein to prevent the water from leaking out.

### BRIEF DESCRIPTION OF THE DRAWINGS

FIG. 1 illustrates a prior art disclosing a conventional bathtub with a low step entryway and a door.

FIGS. 2, 2a and 2b illustrate a bathtub having a sliding door, door seals and bottom sliding rails in the present invention.

FIGS. 3 and 3a illustrate the bathtub viewing from a different angle in the present invention.

FIGS. 4 and 4a illustrates the bathtub viewing from another angle in the present invention.

FIGS. 5 and 5a illustrate the bathtub in different angles when the sliding door is closed in the present invention.

FIG. 5b illustrates the receiving space of the bathtub in the present invention.

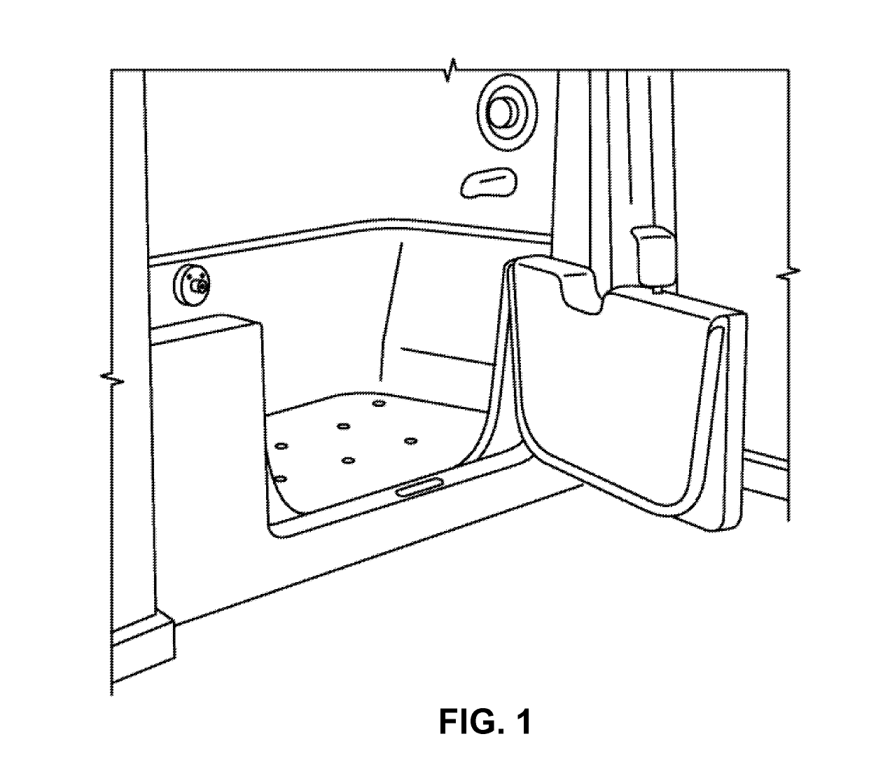

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

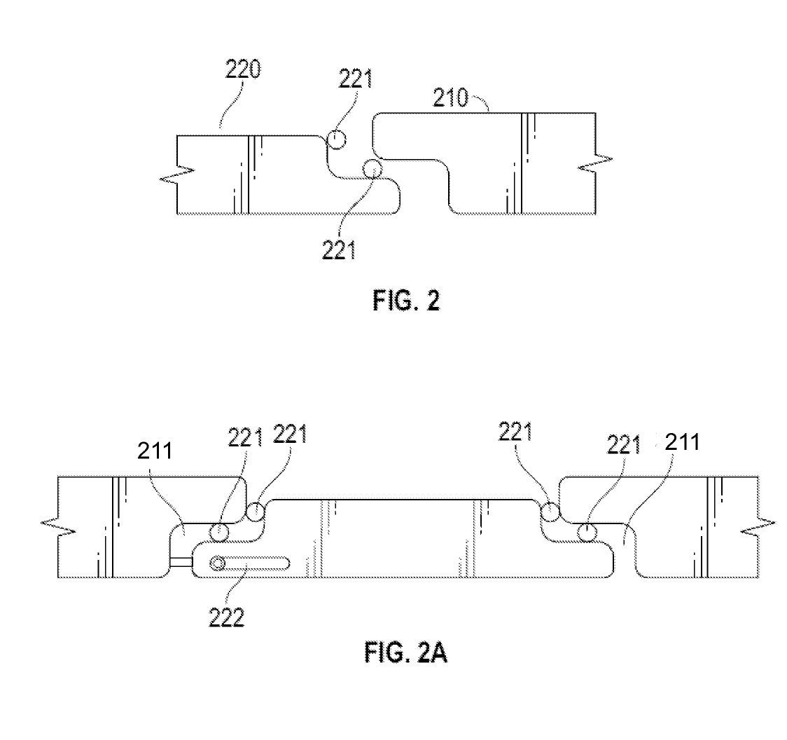

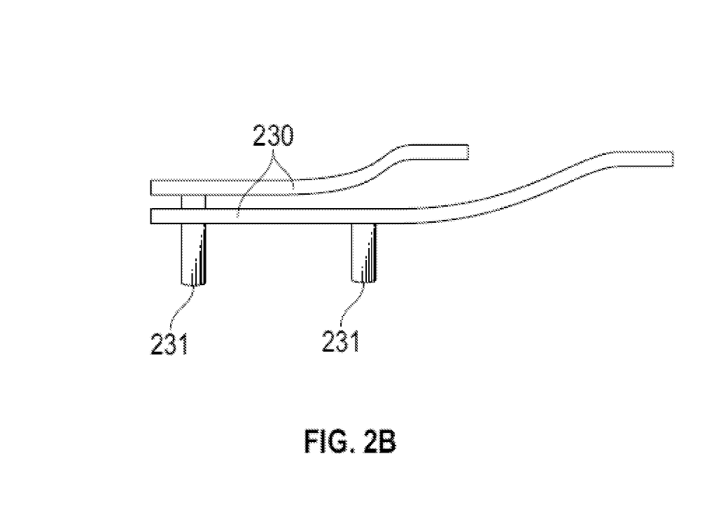

Referring to FIGS. 2, 2a and 2b, a bathtub may include a bathtub frame (210) and a sliding door (220). The bathtub frame (210) has a door receiving space (211) to receive the sliding door (220) and the sliding door (220) may include a plurality of door seals (221) that can be attached to the outer wall of the door receiving space (221) to secure the sliding door (220). The door also includes a door lock (222), so when the door is appropriately positioned in the door receiving space (211), the door lock (222) can be used to further secure the door (220) in a fixed position.

Moreover, the bathtub may include a pair of bottom sliding rails (230) and the sliding door (220) can travel thereon. The bottom sliding rails (230) are secured by a pair of mounting brackets (231) and it is noted that one end of each bottom sliding rail (230) is curved to a predetermined extent to cause the sliding door (220) to slightly tilt before entering the receiving space (211), as shown in FIG. 2. It is also noted that the tilted angle of the sliding door (220) before entering the receiving space (211) is corresponding to the curved end of the bottom sliding rails (230), so that the door seals (221) can be more effectively attach to the wall of the bath frame (210) to secure the door (220).

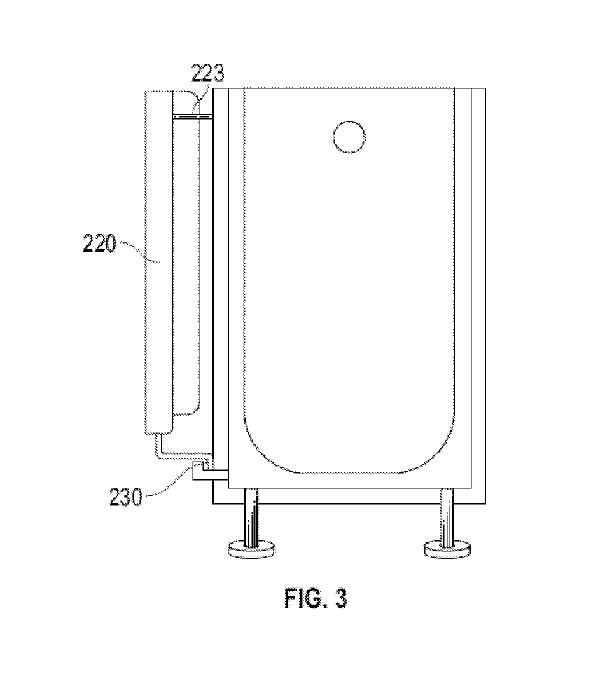

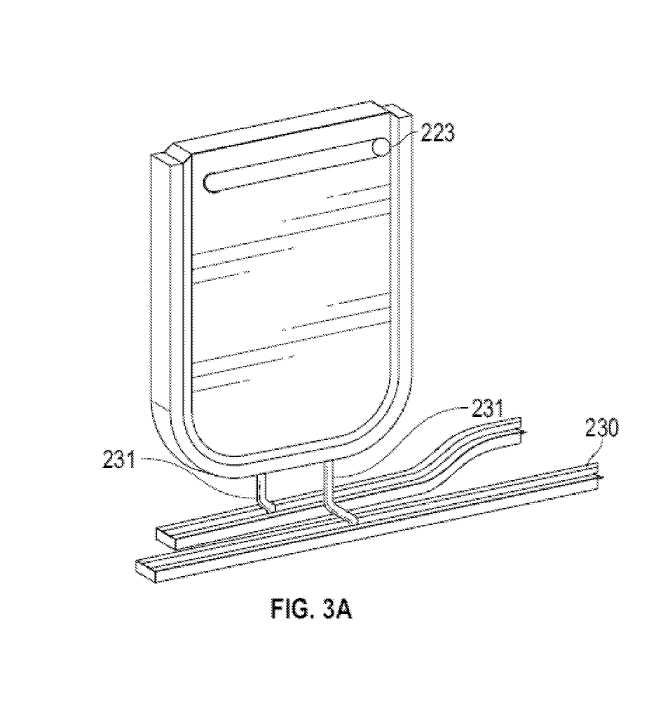

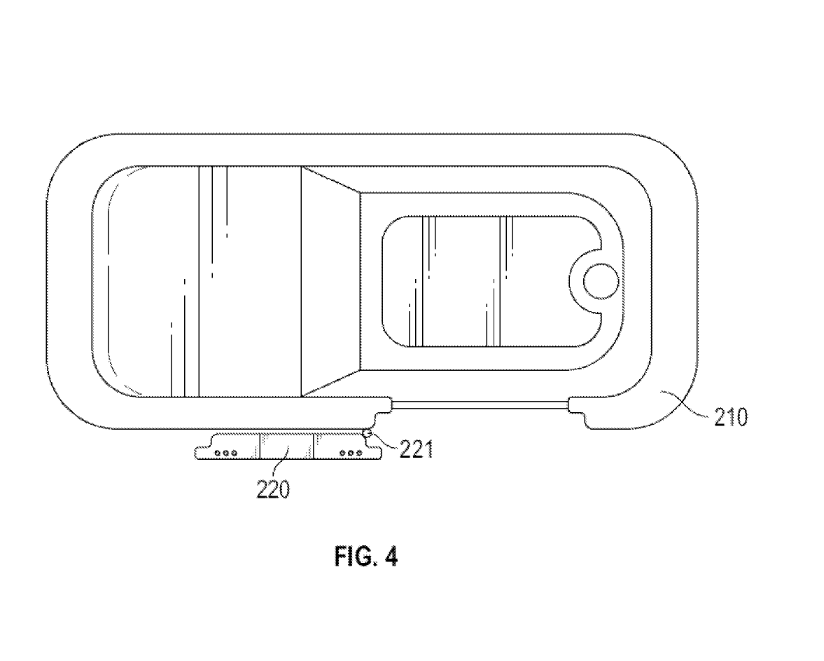

As shown in FIGS. 3 and 3a, the sliding door (220) is also guided by a top sliding rail (223) which is located at a top portion of the sliding door (220). A second seal (212) is formed at the periphery of the receiving space (211) to assure that the door is tightly positioned therein to prevent the water from leaking out.

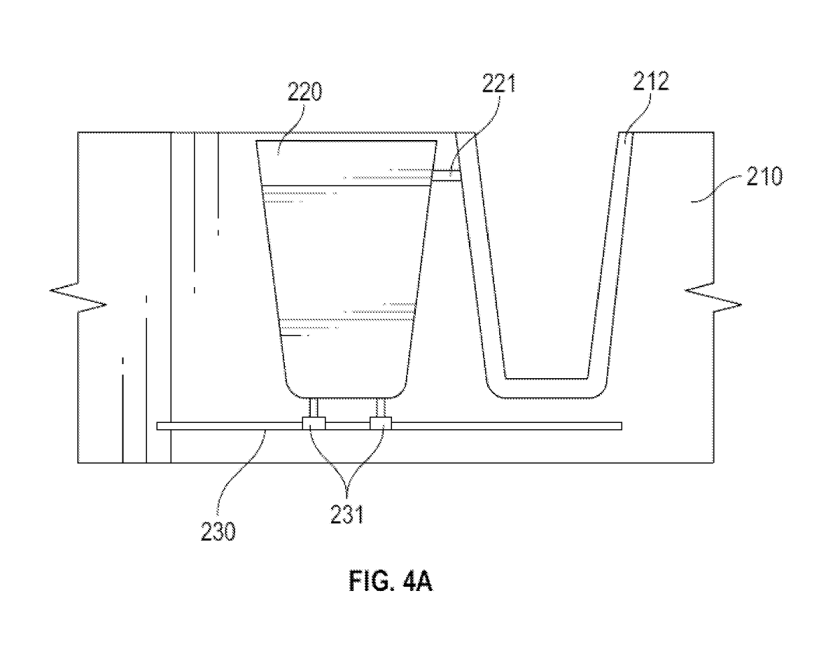

FIGS. 4 and 4a illustrate a top view and a front view of the bathtub with the sliding door (220) respectively. As can be seen in FIGS. 4 and 4a, the sliding door (220) can be moved along both the top sliding rail (223) and bottom sliding rails (230) to finally fit into the door receiving space (211). It is noted that the top sliding rail (223) is used to guide the sliding door (220) to appropriately travel on the bottom sliding rails (230) until reaching the receiving space (211).

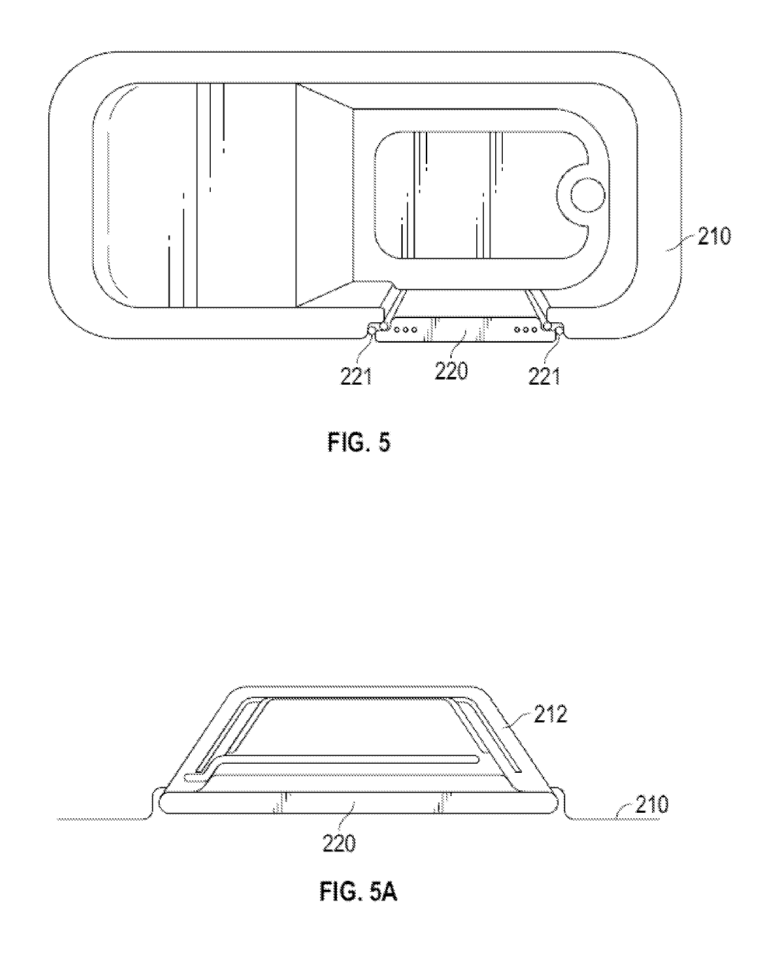

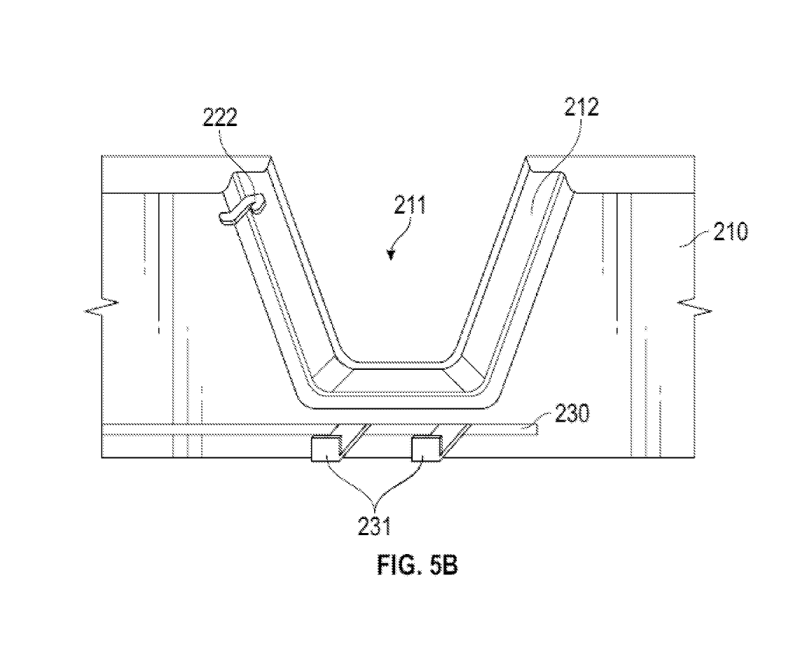

FIGS. 5 and 5a illustrate a top view of the bathtub when the entrance thereof is closed. In addition to the door seals (221), the second seal (212) is formed at the periphery of the receiving space (211) to assured that the door (220) is tightly positioned therein to prevent the water in the bathtub from leaking out. FIG. 5b is a closer look of the disposition of the receiving space (211), the second seal (212), the lock (222), the bottom sliding rails (230) and the mounting brackets (231).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A walk-in bathtub comprising a bathtub frame and a sliding door; said bathtub frame having a door receiving space to receive the sliding door; said sliding door having a plurality of door seals that is attached to an outer wall of the door receiving space to secure the sliding door, wherein the sliding door is guided by a top sliding rail located at a top portion of the sliding door, and travels on a pair of bottom sliding that are secured by a pair of mounting brackets.

2. The walk-in bathtub of claim 1, wherein one end of each bottom sliding rail is curved to a predetermined extent to cause the sliding door to slightly tilt before entering the receiving space, and the tilted angle of the sliding door before entering the receiving space is corresponding to the curved end of the bottom sliding rails, so that the door seals is configured to attach to the wall of the bath frame to secure the door.

3. The walk-in bathtub of claim 1, wherein the door also includes a door lock, so when the door is appropriately positioned in the door receiving space, the door lock is used to further secure the door in a fixed position.

4. The walk-in bathtub of claim 2, wherein the door also includes a door lock, so when the door is appropriately positioned in the door receiving space, the door lock is used to further secure the door in a fixed position.

5. The walk-in bathtub of claim 1, wherein a second seal is formed at a periphery of the receiving space to assured that the door is tightly positioned therein to prevent the water from leaking out.

6. The walk-in bathtub of claim 4, wherein a second seal is formed at a periphery of the receiving space to assured that the door is tightly positioned therein to prevent the water from leaking out.
